(19) United States
(12) Patent Application Publication
(10) Pub. No.: US 2026/0157572 A1
(43) Pub. Date: Jun. 11, 2026

(54) Cylindrical Coffee Grinder Burr Assembly and Method of Grinding

(71) Applicant: Joseph Massimo Fabiani, New York, NY (US)

(72) Inventor: Joseph Massimo Fabiani, New York, NY (US)

(73) Assignee: Joseph Massimo Fabiani, New York, NY (US)

(21) Appl. No.: 18/977,833

(22) Filed: Dec. 11, 2024

(51) Int. Cl. A47J 42/36; A23F 5/08; A47J 42/50

(52) U.S. Cl. CPC A47J 42/36; A23F 5/08; A47J 42/50

(57) ABSTRACT

A novel cylindrical coffee grinder burr type significantly increases the total cutting area possible within a given enclosure size. The design enables more robust support inside and outside the burrs, and creates opportunities to reduce mechanical complexity and product footprint by housing the motor within the circumference of the inner burr, and integrating hopper and anti-retention mechanisms into the outer burr itself.

### FIELD OF THE INVENTION

The present invention relates to coffee grinding apparatuses, specifically to burr grinding assemblies, drive mechanisms, and method of particle size reduction for coffee and similar granular materials. More particularly, the invention encompasses:
1. Burr assembly configurations comprising:
   Rotary and stationary burr elements
   Integrated drive and support mechanisms
   Precision grinding gap control systems
   Modular burr geometry designs
2. Grinding mechanisms and assemblies characterized by:
   Burr size and geometry configurations
   Tooth geometries on burr surfaces
   Material flow control into and between grinding elements
   Reduced mechanical complexity in grinding path design
3. Drive systems for rotational grinding assemblies, including:
   Motor integration strategies
   Bearing support configurations
   Vibration and alignment mitigation techniques
   Precision rotational control mechanisms

The invention addresses technical challenges in grinding apparatus design across various granular material processing applications, with specific embodiments optimized for coffee grinding technologies.

### BACKGROUND OF THE INVENTION

Coffee grinding is a critical process in preparing high-quality coffee beverages. A grinder is adjusted to output a specific particle size of coffee grounds for a given drink, and the spectrum of particle sizes within a specific grind setting serves to enhance or detract from the flavor of the beverage. Larger and more precise burrs tend to produce more uniformly ground coffee, which is desirable especially for coffee drinks such as Espresso. However, increasing the size while maintaining precisely aligned burrs can drastically increase the cost and complexity of a coffee grinder. Existing coffee grinders predominantly utilize two primary burr geometries: conical and flat burrs. These traditional designs have inherent limitations:
1. Complex mechanical assemblies with multiple interdependent parts
2. Challenging alignment requirements
3. Limited surface area for grinding
4. Imprecise grind size adjustments without inherent mechanical advantage
5. Heavy structure required to support rotating components
6. Thread based adjustment mechanisms that complicate disassembly

Current market solutions often address these limitations by:
Increasing both the diameter of the burrs and the size of the complete product
Adding multiple grinding stages
Requiring complex alignment processes involving shims

These approaches typically result in increasingly large, expensive, and mechanically complex grinding systems.

### SUMMARY OF THE INVENTION

The present invention introduces a cylindrical burr design that fundamentally reimagines coffee grinding mechanism architecture. Key innovations include:
1. Integrated direct bearing support within the burr structure
2. Unique adjustment mechanism which has significant mechanical leverage to aid in adjustment precision
3. Simplified mechanical design with fewer parts whose tolerances can compound to result in misalignment
4. Larger grinding surface area relative to overall product size
5. Potential for dynamic hopper sizing based on grind settings
6. Potential for motor and/or gearbox to be housed within the grinder
7. Potential for anti-retention mechanisms integral to the outer burr

The cylindrical burr assembly provides superior grinding performance by:
Reducing mechanical complexity
Improving particle size consistency
Enabling more precise grind size adjustments
Facilitating easier maintenance and cleaning

### DETAILED DESCRIPTION OF THE INVENTION

### Burr Geometry and Mechanical Design

The cylindrical burr design represents a departure from traditional conical and flat burr geometries. Coffee is ground between the circumferences of two nested cylinders, whose height can be extended vertically to increase grind area without increasing the diameter of the burrs, as is necessary in traditional burr designs. Because of their shape, the inventive burr set may also optionally integrate the entire motor, gearbox, and bearings within the burr structure itself.

### Structural Characteristics

Cylindrical shape with unique angular profile (For example, an 87° effective angle, contrasted with 45° for traditional conical burrs or 0° for flat burrs)
Integrated bearing races eliminate the presence of burr carriers or shafts within the tolerance stack
Reduced parts count minimizing potential alignment errors
Enhanced mechanical stability by directly supporting both inner and outer burrs

### Adjustment Mechanism

The invention introduces, but does not require, a novel adjustment mechanism utilizing multiple cams to position whichever burr moves axially. This system is effective in burrs of this type because the steep surface angle grants the adjustment significant mechanical advantage. For instance, with traditional flat and conical burrs, there is a 1:1 ratio between burr separation and grind size, so it is most effective to use traditional fine-pitch threads during adjustment. In an 87 degree cylindrical burr example, the equivalent ratio is 19:1. Thus, instead of a fine-pitch thread, helical cams with multiple starts may be used. This mechanism enables:
Significantly improved adjustment precision
Smoother grind setting transitions
Consistent grind size reproducibility
Elimination of secondary locking mechanisms
Removal of the outer burr without the use of tools using the adjustment ring

### Dynamic Hopper Design

The integral nature of cylindrical burrs allows the hopper to be integrated into the outer burr itself, allowing for several novel features:
Dynamic hopper capacity—because the outer burr moves vertically in relation to the inner burr, the capacity of the hopper increases when grinding coarsely, and decreases when grinding finely.
Spring loaded rotational mechanism—because the top of the outer burr is exposed, the hopper itself can be spring loaded to be used as an anti-retention mechanism wherein it is rotated or plunged before being released, to dislodge retained grounds.

### BRIEF DESCRIPTION OF THE DRAWINGS

The accompanying drawings, which are incorporated into and constitute a part of this specification, illustrate embodiments of the invention and together with the description serve to explain the principles of the invention. The drawings are not necessarily to scale and include:

FIG. 1: Perspective view of complete cylindrical burr assembly

FIG. 2: Perspective view of the cylindrical burr assembly, with the hopper and adjustment ring removed

FIG. 3: Cross-sectional view showing internal motor and bearing integration

FIG. 4: Detailed view of the cam-based adjustment mechanism partially extended

FIG. 5: Hopper design cross section showing spring loaded grind retention mechanism

FIG. 6: Cross sectional view of outer burr alongside inner burr showing the unique shallow grind angle and full profile of the grinding teeth

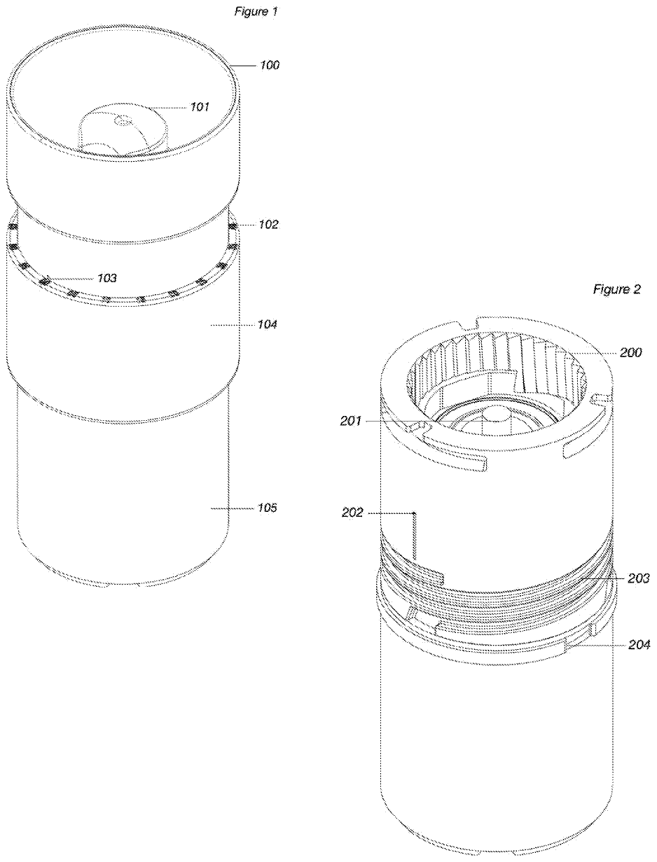

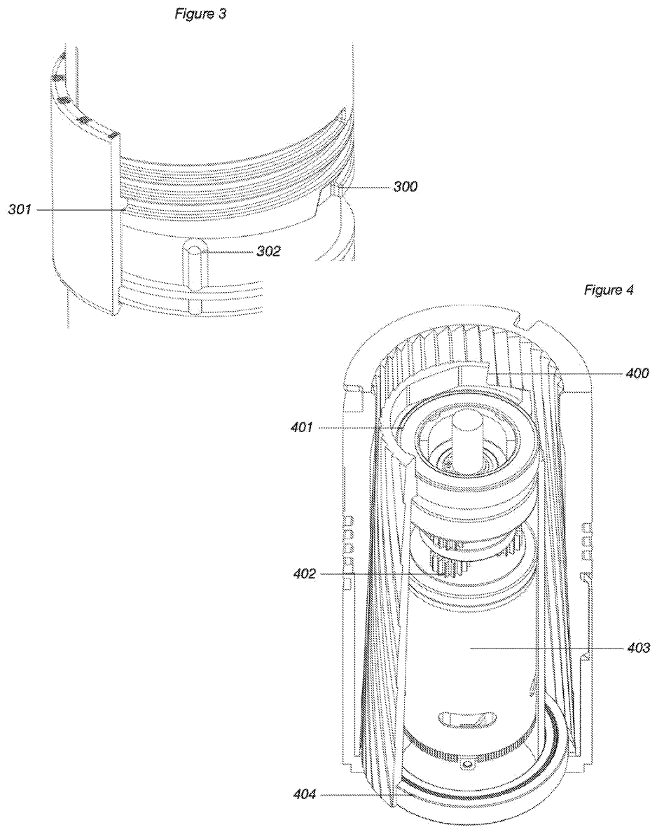

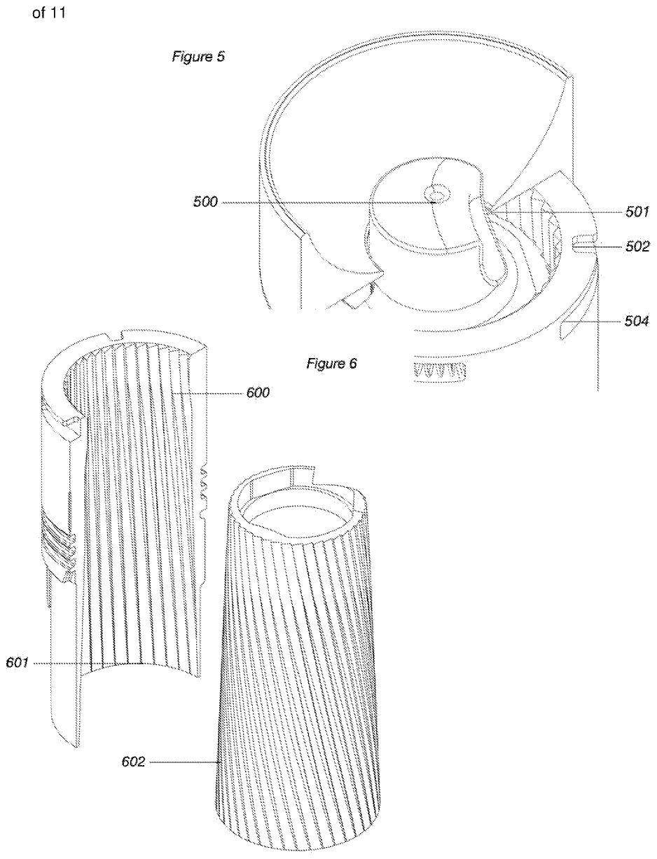

### DETAILED DESCRIPTION OF DRAWINGS

100. Curved conical hopper which holds beans and wherein they are fed by gravity into the grinder.
101. Feed mechanism which stabilizes the flow of coffee beans from the hopper to the burrs to prevent overloading. As this component is constrained to the inner burr and the hopper is constrained to the outer burr, at the maximum grind size setting the feed mechanism will have receded to its lowest point, increasing the effective capacity of the hopper.
102. Numbers inscribed around the circumference of the adjustment ring.
103. Dial indicator which aligns with the number of the selected grind setting is visible
104. Adjustment ring which is turned by hand with a degree range dictated by the cam mechanism inside.
105. Carrier contains lower portion of outer burr vertically and rotationally so that it may move up and down freely.
200. Coarse upper teeth of the outer burr.
201. Motor shaft which applies torque to the inner burr.
202. Fully exposed indicator (partially visible in item 103).
203. Set of helical tracks in which the cams slide during adjustment and otherwise sit.
204. Snap ring which constrains the adjustment ring axially. Alternative solutions include arrangements of screws fastened from the outside perimeter.
300. Entry and exit point for the cams. In this example, a slight angle is employed in the opening to the track so that initial seating of the outer burr is easier.
301. Side of one of three cams in its track.
302. Vertical sliding feature which constrains the rotation of the outer burr, so that the torque of the cams solely translates it vertically.
303. Slot in both the burr carrier and adjustment ring wherein the snap ring (204) is placed.
400. Breaking tooth on the inner or outer burr initially cracks the coffee so that the rest of the surface of the burrs can grind it. The number of breaking teeth can be modified to change the grind intake speed.
401. Top bearing which constrains the outer burr radially. The feed mechanism (101) constrains the outer burr axially and is fixed to the shaft using a set screw. If a feed mechanism is not used, the burr can be fixed to the shaft directly or using a simple coupling component.
402. Optional internal gearing setup to increase the torque of the grinder. In this example, a two stage planetary gearbox reduction with a ratio of 50:1 is used.
403. Optional internal motor. The motor can alternatively be housed outside the gear burr assembly.
404. Bottom bearing sits within the base of the inner burr and directly supports the bottom circumference where the grinding teeth are at their finest point, and where precision is the most important.
500. Hole at the top of the feed mechanism (101) that faces the motor shaft which can be used to press the inner burr out for maintenance if it becomes stuck.
501. Sloped gap in the feed mechanism (101) wherein coffee may enter as it rotates around the perimeter of the intake hole in the hopper (100).
502. Entry point for the bogies of the hopper (503) to nest in their tracks (504).
503. Side view of the bogie in its track (504), loaded in this case by a coil spring. The radius of the track is sufficient that, under power of the spring, the mass of the hopper (100) can impact the outer burr on surface (504) and dislodge retained coffee after grinding is finished.
504. Slot for aforementioned bogies (503) to travel, and its termination point, where impact occurs.
600. Full view of the tooth profile of the outer burr, transitioning from coarse at the top to fine at the bottom.
601. Termination points for the teeth may be cut slightly beyond the diameter of the burr as beyond a certain minimum grind size, grounds may accumulate on non-cutting areas of the surface and prevent the smooth flow of coffee into the grinder.
602. Effective angle of the inner burr is slightly shallower so the teeth may act to gradually reduce the size of the grounds from large to small.

1. A coffee grinder burr assembly comprising:
A near-cylindrical inner burr
A near-cylindrical outer burr

2. The coffee grinder burr assembly of claim 1, wherein said burrs can optionally be configured to hide substantially all motor and gearbox components within their structural geometry.

3. The coffee grinder burr assembly of claim 1, wherein said burrs contain features which allow them to be directly constrained, rotated, and adjusted such as:
Bearing races
Linear sliding rail slots
Motor shaft couplings
Spiral cam tracks

4. Integration of additional features directly within the outer burr including:
Hopper design which is linked to the outer burr directly, and which may change in effective volume during use according to its adjustment.
Anti-retention knockers that are affixed to the outer burr.

5. A method of grinding coffee comprising:
Providing a cylindrical burr assembly
Rotating said burrs relative to each other
Adjusting burr separation via a cam mechanism
